(19) United States
(12) Patent Application Publication
(10) Pub. No.: US 2009/0002286 A1
(43) Pub. Date: Jan. 1, 2009

(54) INFORMATION PROCESSING APPARATUS AND METHOD FOR CONTROLLING ORGANIC EL DISPLAY DEVICE

(75) Inventors: Akihiko Sano, Tokyo (JP); Norikazu Nagasawa, Tokyo (JP)

Correspondence Address: KNOBBE MARTENS OLSON & BEAR LLP, 2040 MAIN STREET, FOURTEENTH FLOOR, IRVINE, CA, 92614, US

(73) Assignee: KABUSHIKI KAISHA TOSHIBA, Tokyo (JP)

(21) Appl. No.: 12/051,467

(22) Filed: Mar. 19, 2008

(30) Foreign Application Priority Data
Jun. 28, 2007 (JP) 2007170758

(51) Int. Cl. G09G 3/30

(52) U.S. Cl. 345/77

(57) ABSTRACT

An information processing apparatus includes: an organic EL display device that displays an image with a plurality of pixels; and a controller that controls the organic EL display device to lower a brightness of the organic EL display device from a first brightness to a second brightness and to invert light-emitting pixels and non-light-emitting pixels among the pixels.

### CROSS-REFERENCE TO RELATED APPLICATIONS

This application is based upon and claims the benefit of priority from Japanese Patent Application No. 2007-170758, filed on Jun. 28, 2007, the entire content of which are incorporated herein by reference.

### BACKGROUND

1. Field

One embodiment of the invention relates to an information processing apparatus, such as a personal computer, and a method for controlling an organic EL display device.

2. Description of the Related Art

Information processing apparatus, such as laptop PCs and PDAs (Personal Digital Assistants) are equipped with a display device. LCDs (liquid crystal displays) and PDPs (plasma display panels) are used as display devices for the information processing apparatus. In recent years, organic EL (electroluminescence) displays have come to be used for such a purpose.

Organic EL displays utilize a phenomenon that light is emitted by excitons that are produced by recombination of electrons and holes injected into an organic substance. The light emission of excitons is very fast and hence a brightness is varied instantaneously when the current is varied. Therefore, a response speed of organic EL displays is very fast. In contrast to liquid crystal displays which produce colors by causing light emitted from a backlight to pass through color filters, organic EL displays can directly generate color light and hence are high in energy conversion efficiency. Furthermore, organic EL displays can be made thinner than liquid crystal displays because a backlight is not necessary.

On the other hand, in organic EL displays, the brightness decreases because the organic substance as the light-emitting body deteriorates gradually due to energization and influences of oxygen and moisture. Although the life can be elongated by limiting the brightness, it is difficult to attain both of high image quality and a long life because the brightness and the life are in a tradeoff relationship.

Furthermore, a screen burning phenomenon occurs in organic EL displays. That is, the brightness is lowered only in particular pixels of the display screen because, for example, the individual pixels are different from each other in the frequency of use.

JP-A-2002-207475 discloses a display device in which the screen burning phenomenon is prevented by changing the entire display screen of an organic EL display gradually from a positive state to a negative state.

However, the technique disclosed in JP-A-2002-207475 cannot elongate the life of an organic EL display although it can prevent the screen burning phenomenon by making the screen uniform by the inversion control.

### SUMMARY

According to a first aspect of the present invention, there is provided an information processing apparatus including: an organic EL display device that displays an image with a plurality of pixels; and a controller that controls the organic EL display device to lower a brightness of the organic EL display device from a first brightness to a second brightness and to invert light-emitting pixels and non-light-emitting pixels among the pixels.

According to a second aspect of the present invention, there is provided a method for controlling a display of an organic EL display device that displays an image with a plurality of pixels, the method including: control the organic EL display device to lower a brightness of the organic EL display device from a first brightness to a second brightness; and control the organic EL display device to invert light-emitting pixels and non-light-emitting pixels among the pixels.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is a perspective view showing an appearance of a computer according to an embodiment of the present invention.

FIG. 2 is a perspective view showing another appearance of the computer according to the embodiment.

FIG. 3 is a block diagram showing a configuration of the computer according to the embodiment.

FIG. 4 is a graph schematically showing a relationship between display brightness and lighting time in controlling an organic EL display according to the embodiment.

FIG. 5 is a chart schematically showing inversion control of display of the organic EL display in the embodiment.

FIG. 6 is a chart schematically showing how light-emission pixels and non-light-emission pixels are switched in the inversion control of display of the organic EL display in the embodiment.

FIG. 7 is a flowchart of the pixel inversion operation of the organic EL display 6 according to the embodiment.

### DETAILED DESCRIPTION

An embodiment of the present invention will be hereinafter described with reference to the drawings.

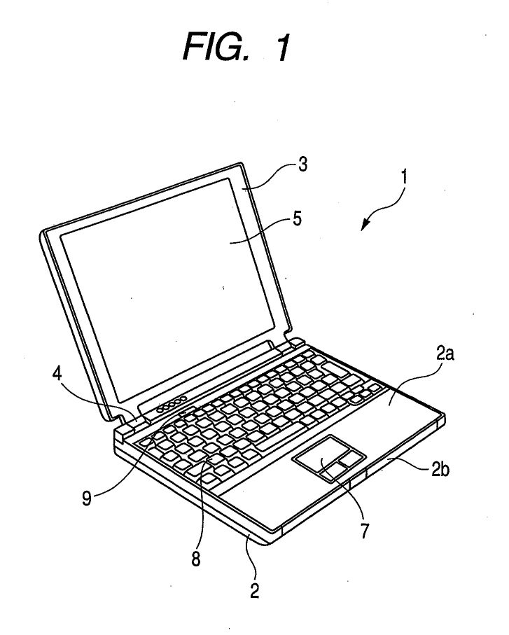

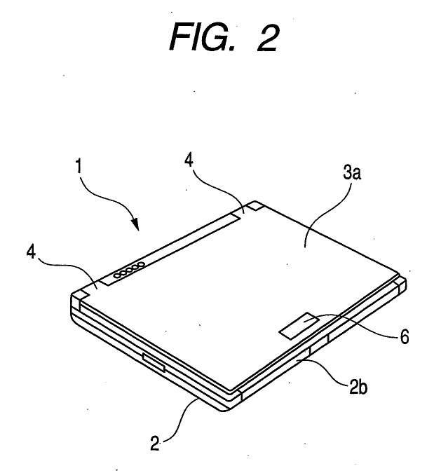

The embodiment is directed to a laptop computer 1 as an information processing apparatus. FIGS. 1 and 2 are perspective views showing appearances of the computer 1 according to the embodiment.

The computer 1 is provided with a main body 2 to which a display unit 3 is attached rotatably via hinge portions 4. The display unit 3 can be swung between an opened position where a top surface 2a of the main body 2 is opened and a closed position where the top surface 2a is covered. FIG. 1 shows a state that the display unit 3 is opened and FIG. 2 shows a state that the display unit 3 is closed. An LCD (liquid crystal display) 5 as a display device is provided inside the display unit 3 and an organic EL display 6 as a sub-display is provided in a back surface 3a of the display unit 3. For example, a time, a warning message, or a notice to the effect that an e-mail has been received is displayed on the organic EL display 6.

Although, in the embodiment, the organic EL display 6 is provided in the back surface 3a of the display unit 3, it may be provided at a different location such as in a front surface 2b of the main body 2. A circuit board mounted with plural electronic components is housed in the main body 2. A touch pad 7 and a keyboard 8 as well as a power switch 9 for powering on/off the computer 1 are provided in the top surface 2a of the main body 2.

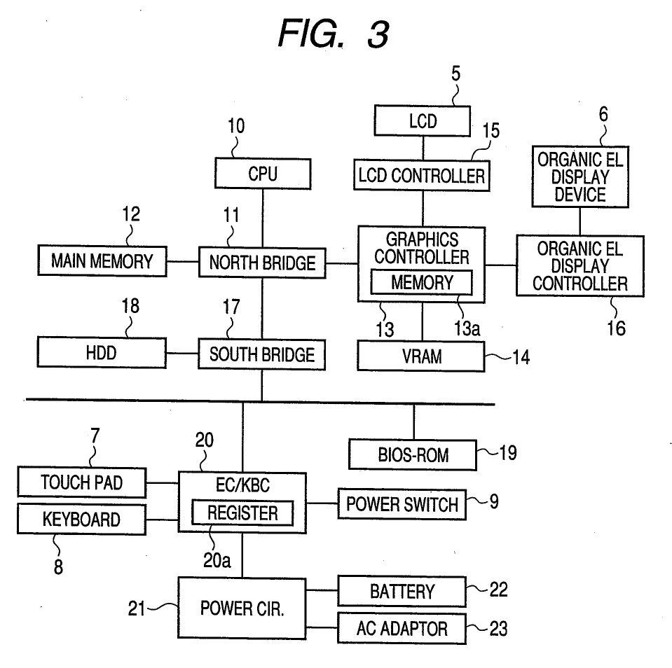

FIG. 3 is a block diagram showing the configuration of the computer 1 according to the embodiment. The computer 1 is equipped with a CPU 10, a north bridge 11, a main memory (RAM) 12, a graphics controller 13, a memory (VRAM) 14, an LCD controller 15, an organic EL display controller 16, a south bridge 17, a hard disk drive (HDD) 18, a BIOS-ROM 19, an embedded controller/keyboard controller IC (EC/KBC) 20, the LCD 5, the organic EL display 6, the touch pad 7, the keyboard 8, and the power switch 9.

The CPU 10 is a processor for controlling the operation of each component of the computer 1. The CPU 10 runs the operating system and various application programs and utility programs which are loaded from the HDD 18 to the main memory (RAM) 12. The main memory (RAM) 12 is also used as various data buffers. The CPU 10 also runs a BIOS (basic input/output system) which is stored in the BIOS-ROM 19. The BIOS is a program for hardware control.

The north bridge 11 is a bridge device for connecting a local bus of the CPU 10 and the south bridge 17. The north bridge 11 also has a function of communicating with the graphics controller 13 via a PCI express bus or the like. The north bridge 11 is provided with a memory controller for controlling the main memory (RAM) 12.

The graphics controller 13 is a display controller for controlling the display contents and the brightness of the organic EL display 6 and the LCD 5 which is used as a display monitor of the computer 1. The graphics controller 13 sends, to the LCD 5 or the organic EL display 6, a video signal corresponding to display data that is written to the video memory (VRAM) 14 by the OS or an application program.

The graphics controller 13 is provided with a memory 13a in which, as described later, pieces of information such as brightness values and a brightness changing time are stored. The LCD controller 15 causes the LCD 5 to display an image by controlling the driving of the LCD 5 according to instructions from the graphics controller 13. The organic EL controller 16 causes the organic EL display 6 to display an image by controlling the driving of the organic EL display 6 according to instructions from the graphics controller 13.

The south bridge 17 is connected to a PCI (peripheral component interconnect) bus and an LPC (low pin count) bus. The HDD 18 stores the OS and various application programs.

The embedded controller/keyboard controller IC (EC/KBC) 20 is a one-chip microcomputer in which an embedded controller for power management and a keyboard controller for controlling the touch pad 7, keyboard 8, etc. are integrated. The EC/KBC 20 performs processing of powering on or off the computer 1 in cooperation with the power circuit 21 in response to a manipulation on the power switch 9 by a user. The power circuit 21 generates power to be supplied to each component of the computer 1 using power supplied from a battery 22 which is incorporated in the computer 1 or power supplied externally via an AC adaptor 23.

The EC/KBC 20 is equipped with a register 20a. Pieces of information such as brightness values and a lighting time that are necessary for controlling the organic EL display 6 are stored in the register 20a. The pieces of information stored in the register 20a are read by the BIOS and written to the memory 13a after activation of the computer 1 and are thereby used for display control by the graphics controller 13.

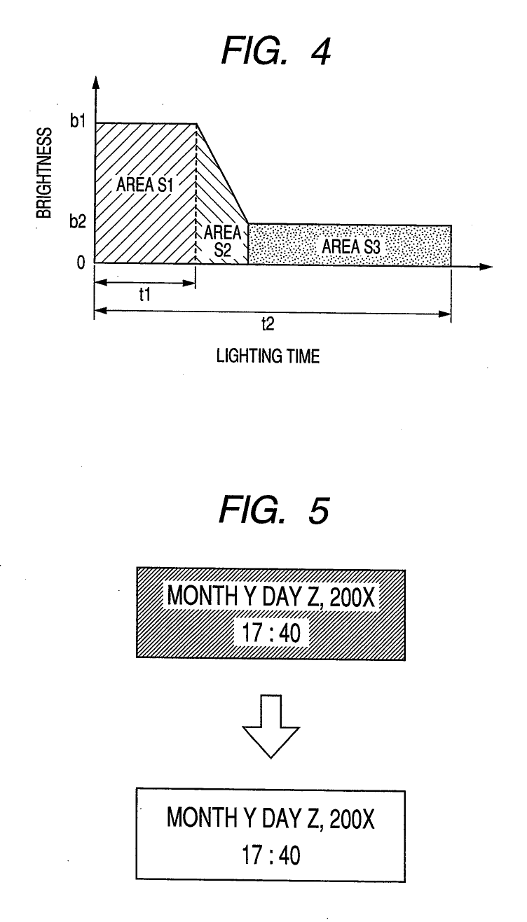

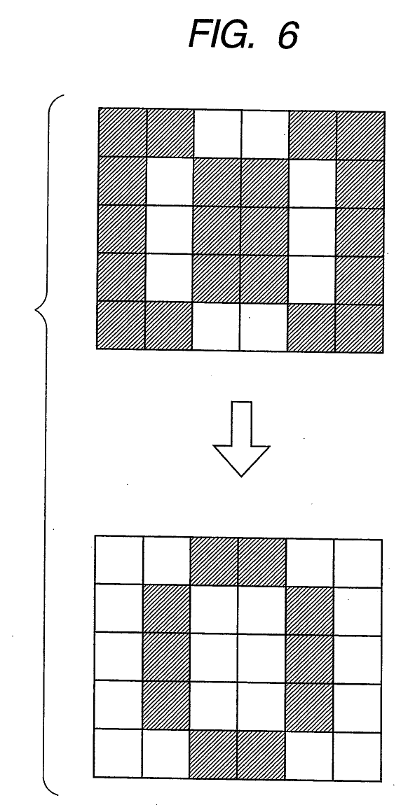

FIG. 4 is a graph schematically showing a relationship between the display brightness and the lighting time of the control of the organic EL display 6 in the embodiment. FIG. 5 is a chart schematically showing inversion control of display of the organic EL display 6 in the embodiment. FIG. 6 is a chart schematically showing how light-emission pixels and non-light-emission pixels are switched in the inversion control of display of the organic EL display 6 in the embodiment.

A description will be made of control that is performed in the embodiment to elongate the display life of the organic EL display 6. The organic EL display 6 is turned on in response to a particular event such as powering-on of the computer 1, closing of the display unit 3, or reception of a new e-mail. The organic EL display 6 performs display at a preset, first brightness b1 hereinafter referred to simply as “first brightness”) which is a constant brightness until a first time period t1 (hereinafter referred to simply as “first time period”) elapses from the turning-on. For example, the first brightness may be the maximum brightness of the organic EL display 6. After a lapse of the first time period from the turning-on of the organic EL display 6, its brightness is lowered gradually to a second brightness b2 (hereinafter referred simply as “second brightness”). The second brightness is set at a smallest value that provides sufficient visibility (e.g., about 20 Cd). To avoid causing a user to feel strange, it is desirable that the control of lowering the brightness from the first brightness to the second brightness last as short a time as possible (e.g., about 1 sec).

After the brightness of the organic EL display 6 has been lowered to the second brightness, the light-emission pixels and the non-light-emission pixels are inverted as shown in FIGS. 5 and 6. In the embodiment, it is assumed that the pixels are inverted immediately after the brightness is lowered to the second brightness. However, the pixels may be inverted after a lapse of a predetermined time period from completion of lowering the brightness to the second brightness. Then, the organic EL display 6 performs display at the second brightness until a second time period t2 (hereinafter referred to simply as “second time period”) elapses. After a lapse of the second time period, the organic EL display is turned off. If particular pixels are used frequently in displaying a time, a warning message, or the like, screen burning may occur due to brightness reduction. In the embodiment, the light-emission pixels and the non-light-emission pixels are inverted upon a lapse of the prescribed time from a start of display of a time, a warning message, or the like, which prevents frequent use of only particular pixels. After the inversion of the light-emission pixels and the non-light-emission pixels, display is performed at the second brightness which is lower than the first brightness, which makes it possible to make the display life longer than in a case that the light-emission pixels and the non-light-emission pixels are merely inverted.

In the above description, the light-emission pixels and the non-light-emission pixels are inverted after the brightness of the organic EL display 6 is lowered from the first brightness to the second brightness. However, an alternative control is possible in which the light-emission pixels and the non-light-emission pixels are inverted at a certain time point during the period when the organic EL display 6 performs display at the first brightness and then the brightness of the organic EL display 6 is lowered to the second brightness.

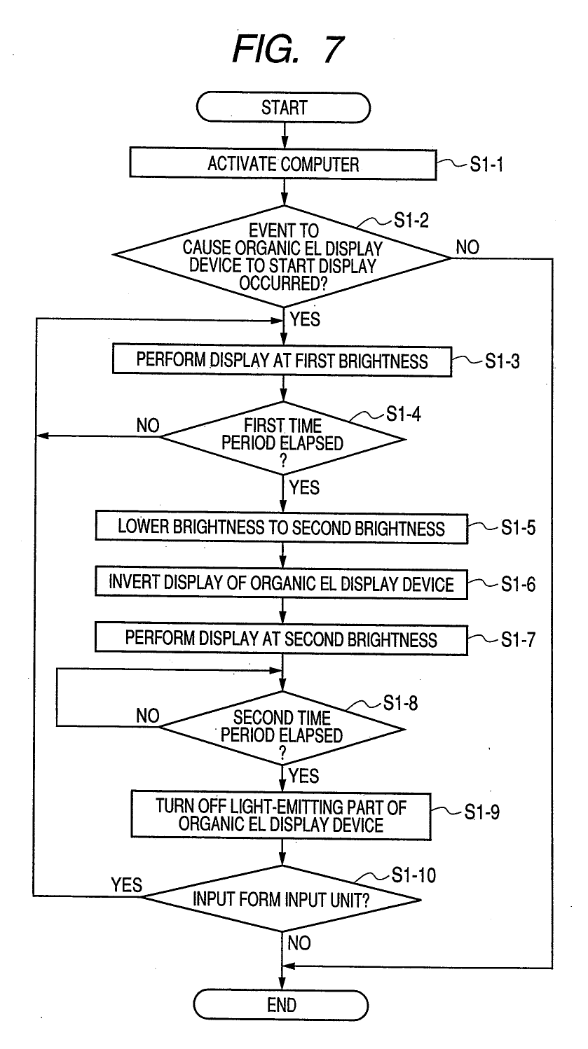

FIG. 7 is a flowchart of the pixel inversion operation of the organic EL display 6 according to the embodiment of the invention. First, at step S1-1, the computer 1 is activated upon depression of the power switch 9. When an event to cause the organic EL display 6 to start display (e.g., arrival of timing for display of a time, closing of the display unit 3, depression of a particular key, or reception of a new e-mail) has occurred (step S1-2: yes) after the powering-on of the computer 1, at step S1-3 the organic EL display 6 is turned on and display suitable for the event is performed at the first brightness. The organic EL display 6 continues the display at the preset first brightness until the first time period elapses from the tuning-on of the organic EL display 6 (step S1-4: no). When the first time period has elapsed from the tuning-on of the organic EL display 6 (step S1-4: yes), at step S1-5 the brightness is lowered from the first brightness to the second brightness which is the lowest brightness that can provide sufficient visibility. Then, the light-emission pixels and the non-light-emission pixels are inverted at step S1-6. Then, the organic EL display 6 performs display at the second brightness at step S1-7. Upon a lapse of the second time period from the tuning-on of the organic EL display 6 (step S1-8: yes), at step S1-9, the light-emitting part of the organic EL display 6 is turned off. Even after the turning-off of the light-emitting part of the organic EL display 6, if input is made through an input unit such as the touch pad 7 or the keyboard 8 (step S1-10: yes), the brightness of the organic EL display 6 is returned to the first brightness and display suitable for the input through the input unit is performed (step S1-3).

Since the display of the organic EL display 6 is controlled according to the above process, not only can use of only particular pixels be prevented but also the display life can be elongated because the brightness is lowered as time elapses. That is, the embodiment can provide a display device capable of making the reduction in screen brightness uniform and elongating the display life, as well as an information processing apparatus having such a display device.

As described with reference to the embodiment, there is provided a display device capable of making the reduction in screen brightness uniform and elongating the display life, as well as an information processing apparatus having such a display device.

The present invention is not limited to the embodiment described above, but the invention may be embodied in practice by modifying constituent components without departing the scope of the claimed invention. Various kinds of inventions may be realized by proper combination of the plurality of constituent components disclosed in the embodiment described above. For example, some constituent components may be eliminated from all the components shown in the above embodiments. Moreover, constituent components in different embodiments may be appropriately combined.

What is claimed is:

1. An information processing apparatus comprising:
an organic electroluminescent (EL) display device configured to display an image with a plurality of pixels; and
a controller configured to control the organic EL display device to lower the brightness of the plurality of pixels of the organic EL display device from a first brightness to a second brightness and to invert light-emitting pixels and non-light-emitting pixels amongst the plurality of pixels.

2. The apparatus according to claim 1, wherein the controller is configured to control the organic EL display device to invert the light-emitting pixels and the non-light-emitting pixels after lowering the brightness from the first brightness to the second brightness.

3. The apparatus according to claim 2, wherein the controller is configured to control the organic EL display device to invert the light-emitting pixels and the non-light-emitting pixels immediately after lowering the brightness from the first brightness to the second brightness.

4. The apparatus according to claim 2, wherein the controller is configured to control the organic EL display device to invert the light-emitting pixels and the non-light-emitting pixels after the lapse of a predetermined time period from completion of lowering the brightness from the first brightness to the second brightness.

5. The apparatus according to claim 1, wherein the controller is configured to control the organic EL display device to lower the brightness from the first brightness to the second brightness after inverting the light-emitting pixels and the non-light-emitting pixels.

6. The apparatus according to claim 1, wherein the controller is configured to control the organic EL display device to start lowering the brightness to the second brightness after the lapse of a first time period from turning-on the organic EL display device, and
wherein the controller is configured to control the organic EL display device to turn off after the lapse of a second time period that is longer than the first time period from completion of lowering the brightness to the second brightness.

7. The apparatus according to claim 1, wherein the controller is configured to control the organic EL display device to gradually lower the brightness from the first brightness to the second brightness.

8. The apparatus according to claim 6 further comprising an input unit configured to allow a user to input operations, wherein the controller is configured to control the organic EL display device to display in the first brightness when an operation is input by the user through the input unit while the organic EL display device is turned off.

9. A method for controlling a display of an organic electroluminescent (EL) display device that is configured to display an image with a plurality of pixels, the method comprising:
controlling the organic EL display device to lower the brightness of the plurality of pixels of the organic EL display device from a first brightness to a second brightness; and
controlling the organic EL display device to invert light-emitting pixels and non-light-emitting pixels among the plurality of pixels.

10. The method according to claim 9, wherein the organic EL display device is controlled to invert light-emitting pixels and non-light-emitting pixels after lowering the brightness from the first brightness to the second brightness.

11. The method according to claim 10, wherein the organic EL display device is controlled to invert the light-emitting pixels and the non-light-emitting pixels immediately after lowering the brightness from the first brightness to the second brightness.

12. The method according to claim 10, wherein the organic EL display device is controlled to invert the light-emitting pixels and the non-light-emitting pixels after the lapse of a predetermined time period from completion of lowering the brightness from the first brightness to the second brightness.

13. The method according to claim 9, wherein the organic EL display device is controlled to lower the brightness from the first brightness to the second brightness after inverting the light-emitting pixels and the non-light-emitting pixels.

14. The method according to claim 9, wherein the organic EL display device is controlled to start lowering the brightness to the second brightness after the lapse of a first time period from turning-on the organic EL display device, and
wherein the organic EL display device is controlled to turn off after the lapse of a second time period that is longer than the first time period from completion of lowering the brightness to the second brightness.

15. The method according to claim 9, wherein the organic EL display device is controlled to gradually lower the brightness from the first brightness to the second brightness.

16. The method according to claim 15 further comprising:
allowing a user to input operations; and
controlling the organic EL display device to display in the first brightness when an operation is input by the user while the organic EL display device is turned off.
